(19) United States
(12) Patent Application Publication
(10) Pub. No.: US 2016/0250895 A1
(43) Pub. Date: Sep. 1, 2016

(54) TIRE WITH PRE-FORMED TREAD AND METHOD OF MAKING SAME

(71) Applicant: Bridgestone Americas Tire Operations, LLC, Nashville, TN (US)

(72) Inventors: Jon I. Stuckey, Louisville, OH (US); Samuel Givens, Copley, OH (US); Dennis W. Snyder, Uniontown, OH (US); Jacob Walters, Medina, OH (US); Adam K. Nesbitt, Akron, OH (US); Edward Seroka, Akron, OH (US)

(21) Appl. No.: 15/050,832

(22) Filed: Feb. 23, 2016

Related U.S. Application Data
(63) Continuation of application No. 14/182,421, filed on Feb. 18, 2014.
(60) Provisional application No. 61/846,591, filed on Jul. 15, 2013.

(51) Int. Cl. B60C 11/03; B29C 47/00; B29C 43/02; B29C 43/52; B29D 30/58; B29D 30/06

(52) U.S. Cl. CPC B60C 11/0311; B29D 30/58; B29D 30/0601; B29C 43/021; B29C 43/52; B29C 47/0064; B29K 2021/00

(57) ABSTRACT

A tire manufacturing method includes providing a green carcass and forming a plurality of green tread segments by a compression molding process. The method further includes assembling the plurality of green tread segments about the green carcass, thereby forming a green carcass and tread assembly, the tread having at least two bars and at least one void. The method also includes introducing the green carcass and tread assembly to a tread negative, aligning the at least two bars with corresponding mold features, and vulcanizing the green carcass and tread assembly.

### CROSS-REFERENCE TO RELATED APPLICATIONS

This application is a continuation of U.S. patent application Ser. No. 14/182,421, filed on Feb. 18, 2014, which claims priority from U.S. Provisional Patent Application No. 61/846,591, filed on Jul. 15, 2013. The disclosure of these applications is incorporated by reference herein in their entirety.

### FIELD OF INVENTION

This disclosure relates to the field of tire constructions and methods of tire construction. More particularly, the disclosure relates to tires with features such as ribs, lugs, bars, or tread blocks and methods of making tires with these features. Further, the disclosure also describes agricultural tires and methods of making agricultural tires.

### BACKGROUND

Known tire manufacturing methods involve building a green tire, including a green tread, and vulcanizing the green tire and tread in a mold. When a green tire is placed in a mold, the volume between the green tire and the mold features must be filled with rubber. Thus, viscous rubber flows into the volume between the green tire and the mold features. The viscous rubber and green tire are cured during vulcanization.

### SUMMARY OF THE INVENTION

In one embodiment, a tire manufacturing method includes providing a green carcass and providing a compression mold having a shape corresponding to a negative of a tread segment having at least two bars and at least one void. The method further includes placing green rubber in the compression mold and molding the green rubber in the compression mold without vulcanizing the green rubber, thereby forming a green tread segment having at least two bars and at least one void. The method also includes removing the green tread segment from the compression mold and assembling the green tread segment about the green carcass, thereby forming a green carcass and tread assembly. The method further includes introducing the green carcass and tread assembly to a tread negative, aligning the at least one bar with a corresponding mold feature, and vulcanizing the green carcass and tread assembly in order to obtain a vulcanized tire.

In another embodiment, a tire manufacturing method includes providing a green carcass and forming a plurality of green tread segments by a compression molding process. The method further includes assembling the plurality of green tread segments about the green carcass, thereby forming a green carcass and tread assembly, the tread having at least two bars and at least one void. The method also includes introducing the green carcass and tread assembly to a tread negative, aligning the at least two bars with corresponding mold features, and vulcanizing the green carcass and tread assembly.

In yet another embodiment, a tire manufacturing method includes providing a green carcass, providing a compression mold having inverse tread features, and placing green rubber in the compression mold. The method also includes compression molding the green rubber in the compression mold without vulcanizing the green rubber, thereby forming a green tread segment having tread features. The method further includes removing the green tread segment from the compression mold, assembling the green tread segment about the green carcass, and vulcanizing the assembled green carcass and green tread segment.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a partial perspective view of one embodiment of a green tread sheet;

FIG. 2 is a partial perspective view of one embodiment of a pre-formed bar;

FIG. 3 is a partial top plan view of one embodiment of a green tread segment having a plurality of pre-formed bars placed thereon;

FIG. 4 is a partial top plan view of one embodiment of a green tread segment having a plurality of pre-formed ribs placed thereon;

FIG. 5 is perspective view of one embodiment of a compression mold configured to receive green rubber;

FIG. 6 is a perspective view of one embodiment of a green tread segment formed in a compression mold;

FIG. 7 is a perspective view of one embodiment of an assembled green tire;

FIG. 8 is a perspective view of a one embodiment of tire mold having mold features and a green tire disposed therein;

FIG. 9 is a side view of an alternative embodiment of a green tread sheet; and

FIG. 10 is a perspective view of an exemplary tire tread vulcanization mold.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Sidewall” as used herein, refers to that portion of the tire between the tread and the bead.

“Tread” as used herein, refers to that portion of the tire that comes into contact with the road or ground under normal inflation and load.

While similar terms used in the following descriptions describe common tire components, it is understood that because the terms carry slightly different connotations, one of ordinary skill in the art would not consider any one of the following terms to be purely interchangeable with another term used to describe a common tire component.

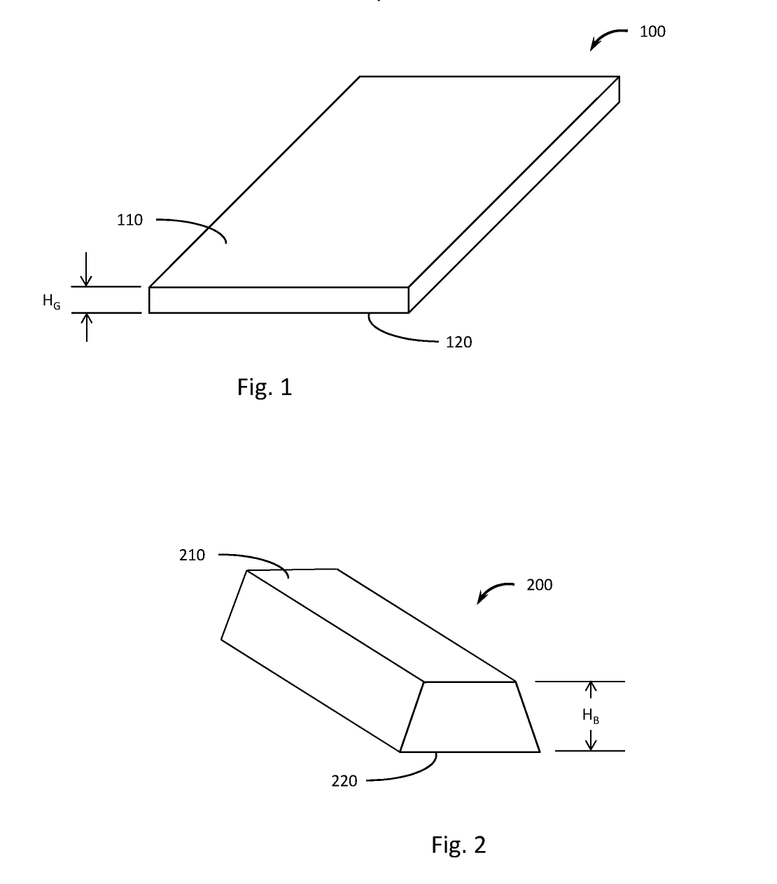

FIG. 1 illustrates a partial perspective view of one embodiment of a green tread sheet 100. As one of ordinary skill in the art would understand, a green tread is a rubber member that has yet to be vulcanized. The green tread may also be referred to as green rubber or green compound. More specifically, the green tread may be referred to as a green tire rubber or green tire compound. The green tread may also be referred to by the specific tire type for which it will be used. For example, the green tread may be referred to as green agricultural tire tread rubber or green agricultural tire tread compound.

The green tread sheet 100 is a substantially flat extruded component. The green tread sheet 100 has a top surface 110 and a bottom surface 120. Top surface 110 and bottom surface 120 are separated by a tread gauge height, H_{G}. The green tread sheet 100 can be used in a variety of different tire applications. While the green tread sheet 100 is shown as being substantially flat, it should be understood that the green tread sheet 100 may be curved in the lateral direction so as to better conform to the shape of a tire carcass.

As one of ordinary skill in the art will understand, the green tread sheet 100 is placed on a tire carcass to form a green tire (not shown). The tire carcass includes a pair of annular beads configured to secure the tire to a wheel. The tire carcass further includes at least one body ply extending between the annular beads. The tire carcass also includes a circumferential belt configured to provide structural reinforcement to the tire.

The green tire is then placed in a vulcanization mold. During curing of the green tire, rubber flows into voids of the vulcanization mold. To reduce the amount of rubber that must flow into the voids of the vulcanization mold, certain tread elements, such as bars, lugs, and ribs, may be pre-formed on the green tread. In one embodiment, bars, lugs, or ribs may be formed separately from the sheet of green tread sheet 100.

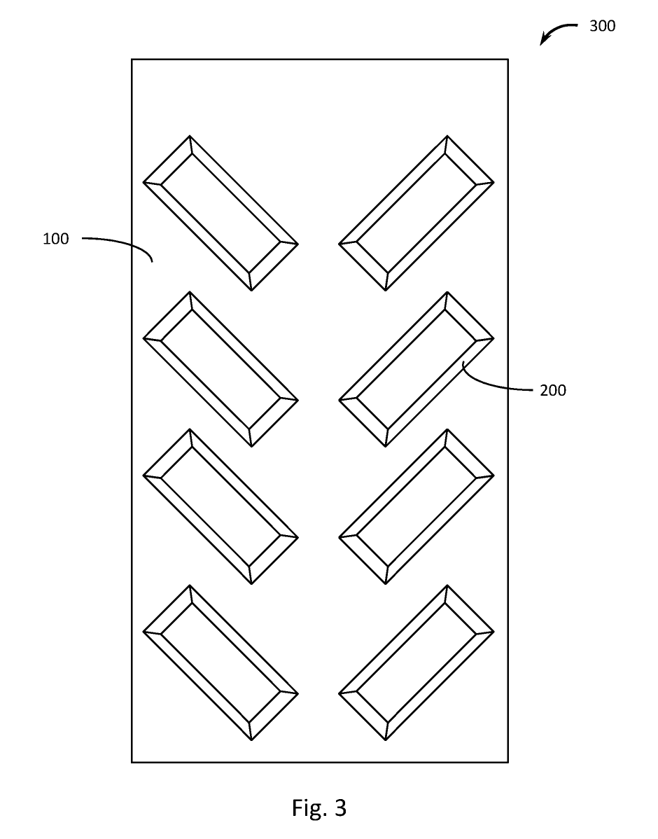

FIG. 2 illustrates one embodiment of a partial perspective view of a pre-formed bar (or lug) 200. In the illustrated embodiment, the bar 200 has a substantially trapezoidal cross-section. In an alternative embodiment (not shown), the bar has a rectangular cross-section. In another alternative embodiment (not shown), the bar has curved sides. In other alternative embodiments (not shown), the cross-section of the bar may be of any geometric shape.

The bar 200 has a top surface 210 and a bottom surface 220. The bar 200 has a bar height, H_{B}, which represents the distance between top surface 210 and the bottom surface 220. The bar 200 may be defined by a bar angle that represents the average inclination of the bar with respect to the tread's equatorial plane.

In one embodiment, the bar 200 is extruded, and then cut to a desired length. In an alternative embodiment, the bar 200 is molded. In another alternative embodiment, the bar 200 is formed by a 3-D printing or additive manufacturing process. In other alternative embodiments, the bar 200 may be formed by any known process.

After the green tread sheet 100 and a desired number of bars 200 are separately formed, the bars 200 are then either placed on or affixed to the green tread sheet 100. In one embodiment (not shown), recesses may be formed in the green tread sheet, with the recesses having a shape corresponding to the shape of the bars. The bars may then be received in the recesses of the green tread sheet.

FIG. 3 illustrates a partial top plan view of one embodiment of an assembled green tread segment 300 including a green tread sheet 100 having a plurality of bars 200 placed thereon. It should be understood that the illustrated placement is merely exemplary, and the bars may be positioned in any desired pattern.

In one embodiment, the bars 200 are simply placed on the green tread sheet 100 at desired locations, and the bars 200 bond to the green tread sheet 100 during a curing process. Alternatively, the bars 200 may be chemically or mechanically affixed to the tread. In one particular embodiment, the bars 200 are placed on the green tread sheet 100 and then stitched in place with a stitching roller (not shown). The stitching roller may have voids corresponding to the placement of the bars 200.

In one embodiment, the bars 200 are positioned on the green tread sheet 100 after the green tread sheet 100 has been positioned on a tire carcass. In an alternative embodiment, the bars 200 are positioned on the green tread sheet 100 before the green tread sheet 100 has been positioned on a tire carcass.

In one embodiment, the bar height H_{B} of the pre-formed bars 200, varies between 50% and 100% of the combined height (H_{G}+H_{B}) of the green tread sheet 100 and the pre-formed bars 200. In one particular embodiment, the bar height H_{B} of the pre-formed bars 200 varies between 60% and 80% of the combined height (H_{G}+H_{B}) of the green tread sheet 100 and the pre-formed bars 200.

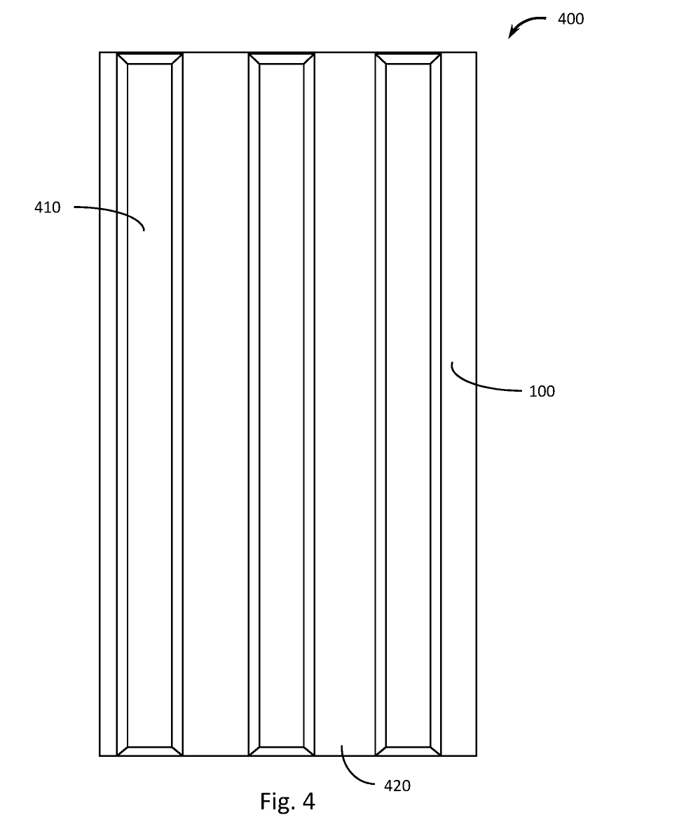

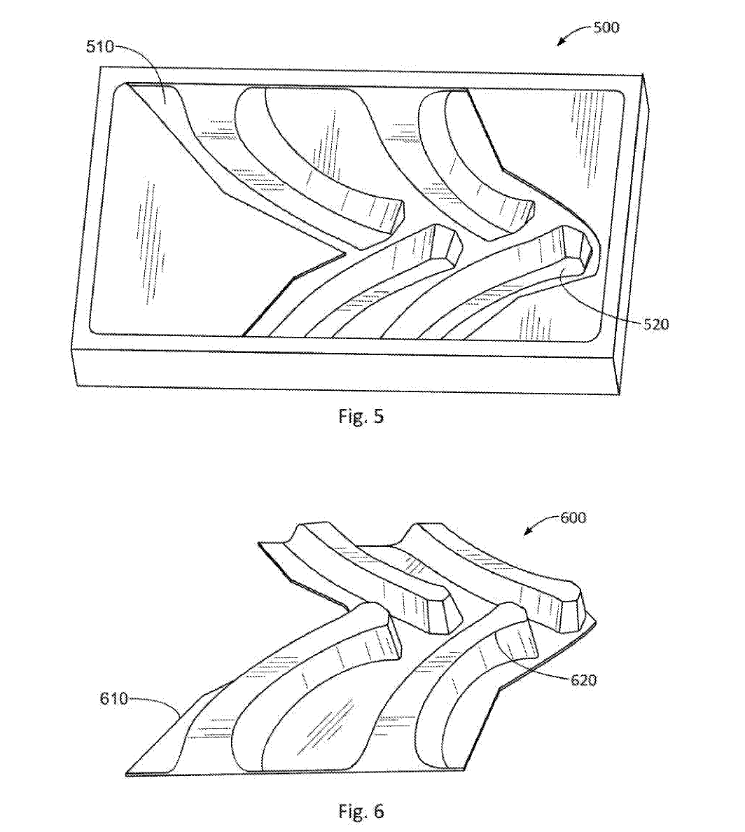

FIG. 4 illustrates a partial top plan view of an alternative embodiment of an assembled green tread segment 400 including a green tread sheet 100 having a plurality of pre-formed ribs 410 placed thereon. As shown, the ribs 400 are divided by circumferential grooves 420. The ribs 410 occupy a portion of the tread's width and will run circumferentially around a finished tire. As one of ordinary skill in the art would understand, the ribs 410 may vary in shape and height, and do not necessarily have to begin or end at any specific location on the tread. In alternative embodiments, the continuity of the ribs is interrupted by various features, including, but not limited to, various grooves, slots, and sipes.

As one of ordinary skill in the art would understand, a tire employing the green tread segment 400 may be suitable for a passenger car or light truck, as well as for larger vehicles.

In one embodiment, the ribs 410 are positioned on the green tread sheet 100 after the green tread sheet 100 has been positioned on a tire carcass. In an alternative embodiment, the ribs 410 are positioned on the green tread sheet 100 before the green tread sheet 100 has been positioned on a tire carcass.

In an alternative embodiment, pre-formed tread elements may be formed with a compression mold. FIG. 5 illustrates a perspective view of one embodiment of a compression mold 500 for forming pre-formed tread elements. The compression mold 500 is generally a negative of a desired tread, and includes a shallow portion 510 that receives rubber corresponding to the base gauge of the tread. The compression mold 500 also includes a deep portion 520 that receives rubber corresponding to the bars of a green tread segment.

Green rubber may be placed in the compression mold 500 by different means. In one embodiment, green rubber placed in the compression mold 500 and pressed with a flat press (not shown). As one of ordinary skill in the art would understand, a flat press is similar to a large vice, and has an upper and lower platen. These platens can move vertically, and as they are closed, force the green rubber into voids in the shallow and deep portions 510, 520 of the compression mold 500. In another embodiment, the green rubber is pressed into the compression mold 500 by hand. In still another embodiment, green rubber is injected into the compression mold 500. In yet another embodiment, green rubber is inserted into the compression mold 500 as it exits an extruder.

In one embodiment (not shown), the compression mold may have a top or a lid. The lid may be used to push the rubber into the voids in the shallow and deep portions 510, 520 of the compression mold 500 when external pressure is applied, such as when upper and lower platens of a flat press are closed.

In the illustrated embodiment, the compression mold 500 is dimensioned to produce a green tread segment that would extend from shoulder to shoulder of a green tire. In an alternative embodiment (not shown), the compression mold is dimensioned to produce a green tread segment that extends across only a portion of the width of the green tire.

In the illustrated embodiment, the compression mold 500 includes four deep portions 520 and is thereby configured to produce a green tread segment having four bars. In an alternative embodiment (not shown), the compression mold includes one to three deep portions and is thereby configured to produce a green tread segment having one to three bars. In other alternative embodiments (not shown), the compression mold may be longer and include any number of bars.

In one embodiment, the green rubber may be warmed prior to being placed into the compression mold 500. Warming the green rubber makes it less viscous, allowing it to fill the compression mold 500 more easily. In one embodiment, the green rubber may be warmed in a furnace or other such device. In an alternative embodiment, the green rubber is warmed through a mixing or extrusion process. In one embodiment, the rubber is warmed to a temperature of 90° C. Alternatively, the rubber may be warmed to a temperature range of 30° C. to 90° C. While increasing the green rubber temperature makes it less viscous, it may be desirable to keep the green rubber below a threshold temperature to prevent the rubber from curing.

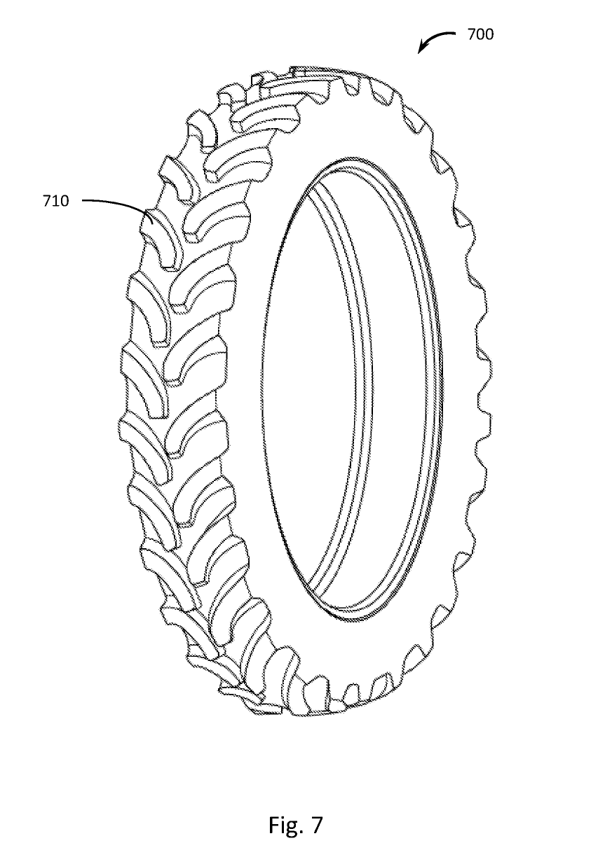

After the compression mold has been completely filled with green rubber, and the forming process is complete, it is allowed to cool if necessary. The green rubber is then removed from the compression mold in the form of a green tread segment, such as the green tread segment 600 shown in FIG. 6. The green tread segment 600 includes a base 610 that forms the bottom of voids. The green tread segment 600 further includes bars 620. While the illustrated green tread sheet 600 includes four bars 620, in alternative embodiments (not shown) the green tread segment may include any number of bars.

In an alternative embodiment, the green tread segment 600 may be formed by a 3-D printing or additive manufacturing process. In other alternatives embodiment, any manufacturing method may be employed to form the green tread segment 600.

In the embodiments described above, the green tread segments 300, 400, 600 are generally shown as being dimensioned to form a portion of a green tread. In such embodiments, multiple green tread segments are placed around the tire carcass. In an alternative embodiment, the green tread segment has a length equal to a circumference of a tire carcass, such that the green tread segment may wrap around the entire tire carcass. In another alternative embodiment, the green tread segment has a length greater than the circumference of the tire carcass, such that the green tread segment may be cut to an appropriate length to wrap around the entire tire carcass. In any of the above described embodiments, the green tread segment may be formed at a first location and transported to a second location to be placed on a tire carcass.

In any of the above described embodiments, the shape of the tread elements (such as bars 200, ribs 410, or bars 620) and the voids between the tread elements generally corresponds to the shape of the tread elements and voids in a cured tire tread. As one of ordinary skill in the art would understand, increasing the similarity between the green tread elements and the mold features will help to reduce rubber flow in the curing press. However, the shape of the green tread elements may depart from the geometry of a cured tread.

In one specific embodiment, the green tread elements generally correspond to a tread negative by occupying at least 40% of a cured tire's void and tread element volume. In another embodiment, the green tread elements generally correspond to larger voids in a tread. In this embodiment, the green tread elements generally correspond to the larger voids in a tread by occupying at least 30% of the cured tire's void volume. In another embodiment, the green tread elements closely correspond to the larger voids in a tread by occupying at least 80% of the cured tire's void volume.

As one of ordinary skill in the art will understand, beginning the process of forming an assembled green tread segment involves forming at least a portion of one of the features that will appear in a finished tire. For example, in a tire for large vehicles, forming an assembled green tread segment could involve pre-shaping a portion of at least one skid lug. In another embodiment, forming an assembled green tread could involve pre-shaping a portion of an agricultural tread profile upon the tread. In yet another embodiment, forming an assembled green tread could involve pre-shaping a portion of a truck or bus tread profile. In a different embodiment, forming an assembled green tread could involve pre-shaping a portion of a passenger tire tread profile.

As one of ordinary skill in the art would recognize, the bars 200, 620 shown in FIGS. 3 and 6 respectively are bars for use on a large tire. Examples of large tires include, but are not limited to, agricultural tires, mining tires, forestry tires, skid steer tires, construction tires, monster-truck tires, and other heavy-duty vehicle tires.

In one particular embodiment, the bars 200, 620 are skid lugs for use on an agricultural tire. In this embodiment, the height of each skid lug is approximately 6% of the tire's width. In additional embodiments, the height of each skid lug is between 3-8% or 4-7% of the tire's width. In further embodiments, the height of each skid lug is between 6-18% of the tire's width. However, it should be understood that the skid lugs may have any height.

In an alternative embodiment (not shown), the bars 200, 620 are deep skid lugs for use on an agricultural tire. In this embodiment, the height of each skid lug is approximately 8% of the tire's width. In additional embodiments, the height of each skid lug is between 5-20% of the tire's width. In further embodiments, the height of each skid lug is between 6-22% of the tire's width. However, it should be understood that the skid lugs may have any height.

In an alternative embodiment, the bars 200, 620 are skid lugs for use on a relatively narrow tire. In this embodiment, the height of each skid lug is approximately 14% of the tire's width. In additional embodiments, the height of each skid lug is between 10-17% of the tire's width. In further embodiments, the height of each skid lug is between 12-19% or 20-35% of the tire's width. However, it should be understood that the skid lugs may have any height.

As one of ordinary skill in the art would recognize, the bars 200, 620 may be used in agricultural tire constructions designated as R1, R1W, and R2 constructions, where R1 corresponds to a standard skid depth (Tire & Rim Association Standard AG-09-21), R1W corresponds to a skid depth that is 20% deeper than R1, and R2 corresponds to a skid depth that is 200% of R1. Additional examples of tires utilizing skids include, without limitation, drive wheels for agricultural vehicles, irrigation tires, forestry tires, floatation tires, combine tires, tractor tires, mining tires, construction tires, sprayer tires, and off-the-road vehicles.

In one embodiment, the bars 200, 620 are arranged to provide a mono-pitch noise-sequenced tread. In an alternative embodiment, the bars 200, 620 are modulated to provide a bi-pitch noise-sequenced tread. In yet another embodiment, the bars 200, 620 are modulated to provide a multi-pitch noise-sequenced tread.

FIG. 7 shows an exemplary green tire 700 having bars 710. The green tire 700 is assembled by placing green tread segments on a tire carcass. The green tread segments may be formed according to any of the methods described above.

The green tire 700 includes a pair of annular beads configured to secure the tire to a wheel. The green tire 700 further includes at least one body ply extending between the annular beads. The green tire 700 also includes a circumferential belt configured to provide structural reinforcement to the tire.

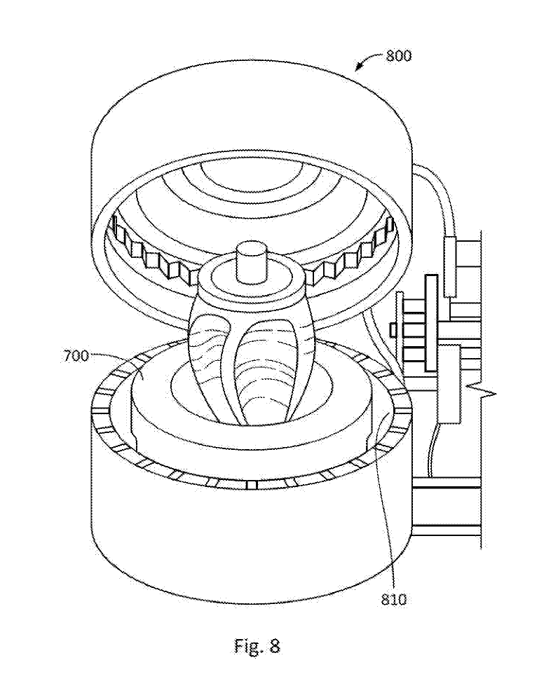

FIG. 8 shows a tire mold 800 with mold features 810. The green tire 700 is disposed in the mold. As one of ordinary skill in the art will appreciate, the mold features are an exact tread negative. In an alternative embodiment, the mold features generally correspond to a tread negative. In another alternative embodiment, the mold features generally correspond to the larger voids in a tread. As one of ordinary skill in the art would understand, the tread or the tire may also be modified post-cure. In another embodiment, the tire tread vulcanization mold may have a smooth interior.

The volume between mold 800 and green tire 700 is less than the volume between the green tire and the mold in prior art systems. In prior molding systems, curing a large tire required approximately 30-240 minutes. Curing a large tire utilizing the molding system shown in FIG. 8 requires less time.

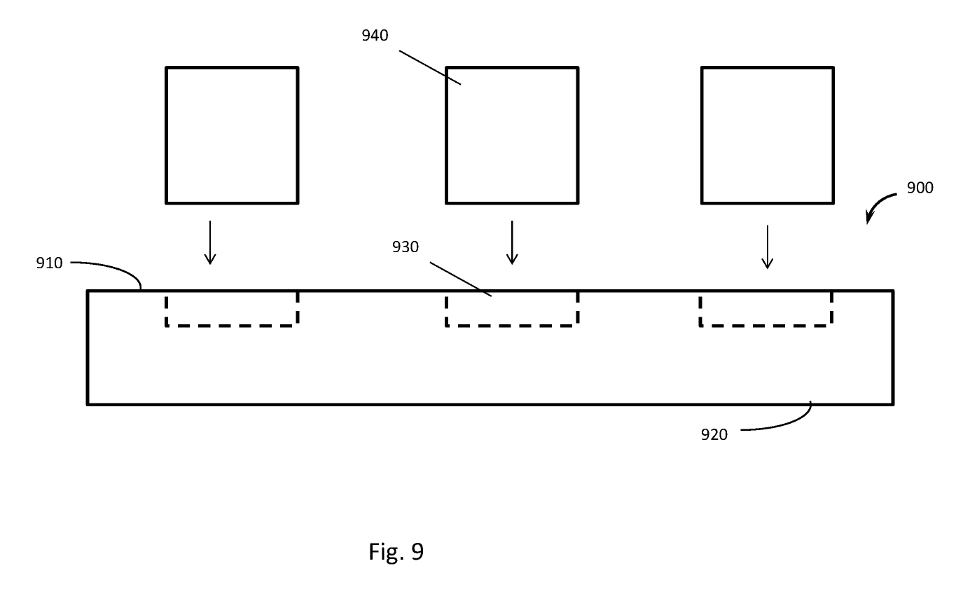

In another alternative embodiment, a green tread is cured or partially cured prior to being placed on a tire carcass. In one such embodiment, the green tread is assembled in one of the manners described above with respect to FIGS. 1-6. Additionally, FIG. 9 illustrates a side view of an alternative embodiment of a green tread sheet 900. The green tread sheet 900 may be formed by an extrusion process, a rolling process, an additive manufacturing process, or other manufacturing processes. The green tread sheet 900 has a top surface 910 and a bottom surface 920, and is a substantially flat component, except for a plurality of recesses 930 formed in the top surface. The recesses 930 have a shape corresponding to the shape of tread elements 940. In one embodiment, the tread elements may be bars (or lugs), such as the bars 200 and alternatives described above with respect to FIGS. 2 and 3. In an alternative embodiment, the tread elements may be ribs, such as the ribs 410 and alternatives described above with respect to FIG. 4.

While the green tread sheet 900 is shown as being substantially flat, it should be understood that the green tread sheet 900 may be curved in the lateral direction so as to better conform to the shape of a tire carcass.

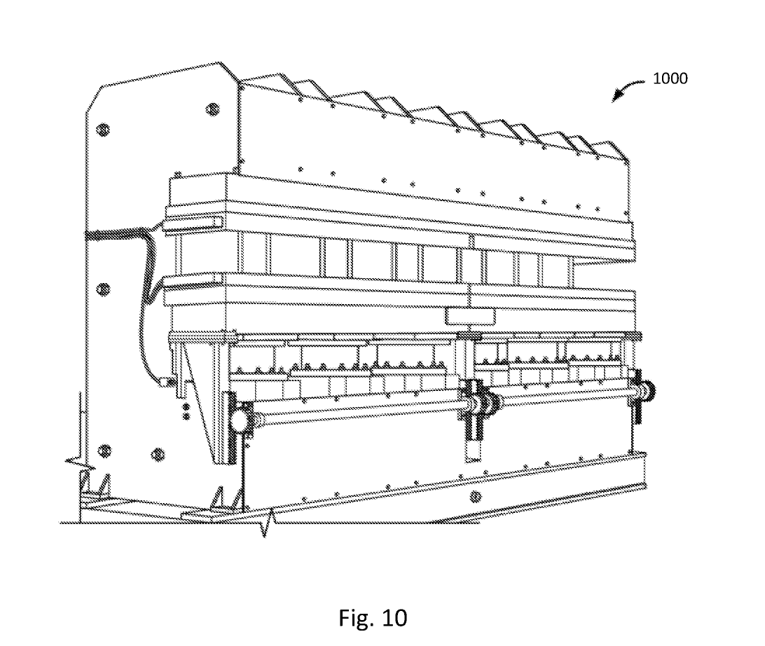

After one of the above described green treads is formed, it is then placed in a tread vulcanization mold, such as the exemplary tire tread vulcanization mold 1000 illustrated in FIG. 10. The details of tire tread vulcanization molds are known in the art and are not repeated here.

The green tread may be cut to an appropriate length according to the dimensions of the tread vulcanization mold 1000. However, it should be understood that the green tire tread strip may be cut to any desired length. The tire tread vulcanization mold 1000 cures the green tire tread by applying heat and pressure, thereby forming a cured tire tread having a first end and a second end. In one embodiment, the tire tread vulcanization mold 1000 applies heat of about 350° F. (180° C.) with pressures of about 350 PSI (2400 kPa). In alternative embodiments, the tire tread vulcanization mold 1000 applies heat of about 300-370° F. (150-190° C.) with pressures of about 200-850 PSI (1370-5800 kPa). Alternatively, the tire tread vulcanization mold 1000 may apply lower heats, lower pressures, or apply such heats and pressures for an abbreviated time period, such that the tread is only partially cured.

In one embodiment, the tire tread vulcanization mold 1000 forms additional features in the tire tread. For example, the tire tread vulcanization mold may form grooves of sipes in the tread. Additionally, the tire tread vulcanization mold may refine the shape of the pre-formed bars, lugs, or ribs. However, it should be understood that the tire tread vulcanization mold need not form any such additional features in the tire tread mold.

In one embodiment, the tire tread vulcanization mold 1000 forms a lateral curve in the tire tread during the curing process. The lateral curve may conform to the lateral curve of the tire carcass. However, it should be understood that the tire tread vulcanization mold need not form a lateral curve in the tire tread mold.

After the tire tread is cured, or partially cured, it may be assembled on a tire carcass in the manner described above. The assembly is then cured in a tire vulcanization mold. In one embodiment, the tire vulcanization mold includes tread element forming features, such as the tire vulcanization mold 800 described above with respect to FIG. 8. In an alternative embodiment, the tire tread vulcanization mold may have a smooth interior. In such an embodiment, tread element forming features may not be required, because the cured or partially cured tread already has the desired tread elements.

As one of ordinary skill in the art will appreciate, the methods and constructions described in this disclosure will increase yield. For instance, reducing the volume between the green tire and the mold features may help improve yield because it reduces rubber flow and resulting gauge variation (such as belt wave) in various reinforcing structures. The methods and constructions described in this disclosure may reduce gauge variation and/or belt wave, particularly in large tires and agricultural tires, where portions of the belt have been known to migrate toward a lug during vulcanization.

Likewise, the methods and constructions described in this disclosure may improve cord distortion and improve tire appearance. The methods and constructions described in this disclosure may also allow for rubber savings. For example, the methods and constructions described herein may require between approximately 10-15% less material.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire manufacturing method comprising:
providing a green carcass;
providing a compression mold having a shape corresponding to a negative of a tread segment having at least two bars and at least one void;
placing green rubber in the compression mold;
compression molding the green rubber in the compression mold without vulcanizing the green rubber, thereby forming a green tread segment having at least two bars and at least one void;
removing the green tread segment from the compression mold;
assembling the green tread segment about the green carcass, thereby forming a green carcass and tread assembly;
introducing the green carcass and tread assembly to a tread negative;
aligning the at least one bar with a corresponding mold feature; and
vulcanizing the green carcass and tread assembly in order to obtain a vulcanized tire.

2. The method of claim 1, further comprising warming the green rubber prior to placing the green rubber in the compression mold.

3. The method of claim 2, wherein the warming the green rubber includes warming the rubber to a temperature between 30° C. and 90° C.

4. The method of claim 2, further comprising cooling the green rubber prior to removing the green rubber from the compression mold.

5. The method of claim 1, wherein the introducing the green carcass and tread assembly to a tread negative includes placing the green carcass and tread assembly into a tire vulcanization mold having the tread negative.

6. The method of claim 5, wherein the vulcanizing the green carcass and tread assembly includes no more than 240 minutes of vulcanization.

7. The method of claim 6, wherein the vulcanizing the green carcass and tread assembly includes applying heat between 150° C. and 190° C.

8. The method of claim 7, wherein the vulcanizing the green carcass and tread assembly includes applying pressure between 1370 kPA and 5800 kPA.

9. The method of claim 1, further comprising repeating the steps of placing green rubber in the compression mold and compression molding the green rubber in the compression mold, thereby forming a plurality of green tread segments.

10. The method of claim 9, wherein the assembling the tread segment about the green carcass includes assembling the plurality of green tread segments about the green carcass.

11. The method of claim 1, wherein the green carcass includes a pair of annular beads and at least one body ply extending between the pair of annular beads.

12. The method of claim 1, wherein the green carcass includes a circumferential belt.

13. The method of claim 1, wherein a height of the at least one bar is at least 20% of a width of the green carcass.

14. The method of claim 1, wherein a height of the at least one bar is at least 40% of a width of the green carcass.

15. A tire manufacturing method comprising:
providing a green carcass;
forming a plurality of green tread segments by a compression molding process;
assembling the plurality of green tread segments about the green carcass, thereby forming a green carcass and tread assembly, the tread having at least two bars and at least one void;
introducing the green carcass and tread assembly to a tread negative;
aligning the at least two bars with corresponding mold features; and
vulcanizing the green carcass and tread assembly.

16. The method of claim 15, wherein the forming a plurality of green tread segments by a compression molding process includes:
providing a compression mold having a shape corresponding to a negative of a tread segment;
placing green rubber in the compression mold, thereby forming a green tread segment; and
removing the green tread segment from the compression mold.

17. The method of claim 16, wherein the forming a plurality of green tread segments by a compression molding process further includes repeating the steps of placing green rubber in the compression mold, and removing the green tread segment from the compression mold.

18. A tire manufacturing method comprising:
providing a green carcass;
providing a compression mold having inverse tread features;
placing green rubber in the compression mold;
compression molding the green rubber in the compression mold without vulcanizing the green rubber, thereby forming a green tread segment having tread features;
removing the green tread segment from the compression mold;
assembling the green tread segment about the green carcass; and
vulcanizing the assembled green carcass and green tread segment.

19. The method of claim 18, further comprising:
introducing the assembled green carcass and green tread segment to a vulcanization mold having a tread negative; and
aligning the tread features with the tread negative.

20. The method of claim 18, further comprising warming the green rubber prior to placing the green rubber in the compression mold.
